(19) United States
(12) Patent Application Publication
(10) Pub. No.: US 2025/0154786 A1
(43) Pub. Date: May 15, 2025

(54) MECHANICAL DIRECTION CHANGE STRUCTURE FOR POOL CLEANER, AND POOL CLEANER

(71) Applicant: WYBOTICS CO., LTD, Tianjin (CN)

(72) Inventors: Pu CEN, Tianjin (CN); Huchen GONG, Tianjin (CN)

(73) Assignee: WYBOTICS CO., LTD, Tianjin (CN)

(21) Appl. No.: 18/838,248

(22) PCT Filed: Aug. 14, 2023
(86) PCT No.: PCT/CN2023/112927

§ 371 Date: Aug. 14, 2024

(30) Foreign Application Priority Data
Aug. 2, 2022 (CN) 202210922419.7
Nov. 14, 2022 (CN) 202211423079.X

(51) Int. Cl. E04H 4/16

(52) U.S. Cl. CPC E04H 4/1654

(57) ABSTRACT

A mechanical direction change structure for a pool cleaner includes a direction change device provided on a pool cleaner body and swingable relative to a pool cleaner, where the direction change device is provided with an abutting unit, and at least one stopping unit rotatable relative to the direction change device; when the pool cleaner is traveling, the stopping unit is in contact with the abutting unit, such that the direction change device maintains a basically stationary state relative to a shell; and when the pool cleaner changes a direction, the stopping unit gradually detaches from the abutting unit and rotates relative to the abutting unit. The stopping unit is rotatable relative to a swinging element. The stopping unit rotates to contact or detach from the abutting unit, thereby enabling the pool cleaner to travel and change its direction.

### CROSS REFERENCE TO THE RELATED APPLICATIONS

This application is the national phase entry of International Application No. PCT/CN2023/112927, filed on Aug. 14, 2023, which is based upon and claims priority to Chinese Patent Applications No. 202210922419.7, filed on Aug. 2, 2022, and No. 202211423079.X, filed on Nov. 14, 2022, the entire contents of which are incorporated herein by reference.

### TECHNICAL FIELD

The present disclosure belongs to the technical field of pool cleaning, and in particular relates to a mechanical direction change structure for a pool cleaner, and a pool cleaner.

### BACKGROUND

When a pool cleaner encounters a wall or an obstacle during the cleaning process of a pool, it needs to change its direction. The existing automatic pool cleaners generally adopt time-based turnaround control, which cannot recognize whether the pool cleaner encounters a wall or an obstacle and make the pool cleaner return or turn. When encountering the wall or the obstacle, the pool cleaner must wait until a set time cycle ends before changing its direction, resulting in significant efficiency loss. Alternatively, some pool cleaners use an electronic component for wall detection, leading to a complex structure and high cost. Alternatively, some pool cleaners achieve direction changes through the cooperation of a swinging element and a stopping element. The existing swinging element rotates with a rotating element, but it is easy to detach from the stopping element in case of an excessive swinging angle.

### SUMMARY

In order to solve the above or other problems existing in the prior art, the present disclosure provides a mechanical direction change structure for a pool cleaner, and a pool cleaner.

The present application provides a mechanical direction change structure for a pool cleaner, including:
a swinging unit, connected to a pool cleaner body and swingable relative to the pool cleaner body;
at least one abutting unit, connected to the swinging unit; and
at least one stopping unit, rotatably connected to the pool cleaner body; and where
during an operation process of the pool cleaner, the stopping unit is located at a position where the stopping unit interferes with or detaches from the abutting unit.

In an implementation, operation of the pool cleaner refers to operation of a power driving element of the pool cleaner; and the pool cleaner is in a moving state or in an obstructed state due to an obstacle or other situation.

Optionally, the swinging unit is provided on the pool cleaner body through the abutting unit.

When the pool cleaner is in the moving state, the abutting unit and the stopping unit are in an interfered state, and the swinging unit, the abutting unit, and the pool cleaner body remains relatively stationary.

During a direction change process of the pool cleaner, the stopping unit gradually detaches from the abutting unit.

Optionally, when the pool cleaner is in the moving state, the swinging unit is tilted backwards relative to the pool cleaner due to a resistance of water, and the abutting unit maintains the interfered state with the stopping unit.

The backwards tilt refers to a tilt in an opposite direction to a forward direction of the pool cleaner.

Optionally, when the pool cleaner is in the obstructed state, due to a rotational force of the stopping unit, the stopping unit rotates to a position where the stopping unit interferes with another abutting unit.

Optionally, when the pool cleaner is in the obstructed state, due to the rotational force of the stopping unit, the stopping unit rotates to a position where the stopping unit interferes with another abutting unit; the rotation of the stopping unit corresponds to the rotation of a rotating water channel; a direction of a water outlet of corresponding discharge channel changes, causing a change in a movement direction of the pool cleaner, such that the pool cleaner breaks away from the obstructed state, thereby achieving a direction change and movement.

Optionally, when the pool cleaner is in the obstructed state and the abutting unit interferes with the stopping unit, the abutting unit is allowed to detach from interfering with the stopping unit due to the rotational force of the stopping unit.

In a specific implementation, when the pool cleaner is in the obstructed state, the resistance of a water flow disappears, and due to the rotational force of the stopping unit, the stopping unit overcomes the blocking of the abutting unit, causing the stopping unit to break away from the interfered state with the abutting unit.

Optionally, when the pool cleaner is in the obstructed state and the swinging unit is restored from the tilted state to a vertical position relative to the pool cleaner body, the stopping unit is in a detached state from the abutting unit; and the stopping unit rotates until a position where the stopping unit interferes with another abutting unit.

Optionally, the stopping unit is connected to the pool cleaner body through a rotating element; the rotating element is the rotating water channel of the pool cleaner, or the rotating element is fixedly connected to a rotating water channel of the pool cleaner;
the rotating water channel is the discharge channel of the pool cleaner and is rotatably connected to the pool cleaner body; and
different positions of the discharge channel correspond to different movement directions of the pool cleaner.

In a specific implementation, when a power drive (a motor driven impeller) of the pool cleaner is running, the rotating element (the stopping unit) is given the rotational force; if the stopping unit and the abutting unit are not in a blocked state, the stopping unit rotates; if the stopping unit is in a blocked state, the stopping unit and the pool cleaner body are relatively stationary, but the rotational force still plays a role.

In a specific implementation, when the pool cleaner is in the moving state, the water flow applies a resistance to the swinging unit, causing the swinging unit to swing backwards relative to the pool cleaner body; the rotational force and the resistance of the water flow overcome a restoring force of the swinging unit, such that the swinging unit keeps swinging backwards relative to the pool cleaner.

In a specific implementation, the mechanical direction change structure includes one stopping unit.

In a specific implementation, the mechanical direction change structure includes two stopping units.

Optionally, the stopping unit includes a first stopping element and a second stopping element; the first stopping element is adjacent to the second stopping element; the first stopping element and the second stopping element are connected to the pool cleaner body through the rotating element; and preferably, the first stopping element and the second stopping element are connected to the pool cleaner body through the same rotating element.

In a specific implementation, the first stopping element and the second stopping element are located at a same side of the rotating element and sequentially arranged along a circumferential direction of the rotating element, such that the abutting unit first contacts the first stopping element during a travel and/or direction change process; and during a movement process, due to the resistance of the water flow, the abutting unit comes into contact with the second stopping element by crossing the first stopping element.

In a specific implementation, along a radial direction of the rotating element, a distance between the second stopping element and an axis of the rotating element is smaller than a distance between the first stopping element and the axis of the rotating element.

Further, a height of the second stopping element is greater than a height of the first stopping element.

Optionally, the first stopping element and the second stopping element respectively interact (in an interfered or detached state) with different abutting positions or different abutting elements of the same abutting unit.

Optionally, during a rotation process of the stopping unit, the abutting unit first passes through a position of the first stopping element, and then passes through a position of the second stopping element.

Optionally, the first stopping element and the second stopping element are located on different circumferences, and the height of the first stopping element is different from the height of the second stopping element; and the circumferences are centered on a rotation center of the rotating water channel.

Optionally, a highest point of the first stopping element in a vertical direction is lower than a highest point of the second stopping element in the vertical direction.

Optionally, the first stopping element is located on a periphery relative to the second stopping element.

In a specific implementation, the first stopping element and the second stopping element are rectangular-solid, cuboid, or cylindrical elements, etc. with a certain vertical height; and according to an actual need, any position of the element, such as an end, is provided with a slope to meet the interaction with the abutting unit.

Optionally, when the first stopping element and the abutting unit change from the interfered state to the detached state, the second stopping element and the abutting unit change from the detached state to the interfered state.

In a specific implementation, when the first stopping element and the abutting unit are in an interfered state (blocked state), the second stopping element and the abutting unit break away from the interfered sate (are in a non-blocked state); when the first stopping element and the abutting unit change from the interfered state to the detached state, the second stopping element and the abutting element change from the detached state to the interfered state; and when the first stopping element and the abutting unit gradually change from the interfered state to the detached state, the second stopping element gradually change from the detached state to the interfered state.

Optionally, due to the rotational force of the stopping unit, the first stopping element changes from a position of interfering with the abutting unit to a position of detaching from the abutting unit.

Optionally, when the pool cleaner is in the moving state, the swinging unit is tilted backwards relative to the pool cleaner due to the resistance of water, and the second stopping element is located at a position where the second stopping element interferes with the abutting unit.

Optionally, when the pool cleaner is in the obstructed state and the swinging unit is tilted backwards to be vertical to the pool cleaner body, the first stopping element and the second stopping element are in the detached state from the abutting unit.

In a specific implementation, when the pool cleaner is in the obstructed state, the resistance of the water flow to the swinging unit disappears, and the first stopping element is in the blocked state with the abutting unit; due to the rotational force of the stopping unit, the first stopping unit overcomes the blocking of the abutting unit, and the swinging unit is restored to a vertical state under the restoring force; the second stopping element crosses the abutting unit, and the stopping unit rotates until the stopping unit is blocked with the abutting unit on the other side; the direction of the water outlet changes and the movement direction of the pool cleaner changes, causing the pool cleaner to break away from the obstructed state and complete the direction change.

In a specific implementation, the rotational force of the stopping unit causes the first stopping element to overcome the blocking of the abutting unit and break away from the blocked state, but the rotation force of the stopping unit does not cause the second stopping element to overcome the blocking of the abutting unit and break away from the blocked state; and the second stopping element breaks away from the blocked state through the swinging unit that is in a vertical state relative to the pool cleaner body.

Optionally, the first stopping element overcomes the blocking of the abutting unit and breaks away from the blocked state through the rotational force of the stopping unit or through the swinging unit that is in a vertical sate relative to the pool cleaner body.

Optionally, when the pool cleaner is in the obstructed state and the swinging unit is tilted backwards relative to the pool cleaner body, if the abutting unit and the first stopping element are in the interfered state, due to the rotational force of the stopping unit, the abutting unit and the first stopping element change from the interfered state to the detached state; the swinging unit is vertical to the pool cleaner body; and the stopping unit rotates to a position where the stopping unit interferes with another abutting unit.

Optionally, due to the rotational force of the stopping unit, the first stopping element changes from a position of interfering with the abutting unit to a position of detaching from the abutting unit, and the second stopping element changes from a position of detaching from the abutting unit to a position of interfering with the abutting unit;
when the pool cleaner is obstructed, the swinging unit is restored to a vertical position, the second stopping element detaches from the abutting unit, and the stopping unit rotates until the first stopping element or the second stopping element interferes with another abutting unit; and/or
when the swimming pool cleaning is in the moving state, due to the resistance of water, the swinging unit is tilted backwards relative to the pool cleaner in a vertical plane thereof, and the second stopping element interferes with the abutting unit.

Optionally, the mechanical direction change structure includes two abutting units.

In a specific implementation, the two abutting units have a same structure; and preferably, the two abutting units are symmetrically positioned and structurally identical.

Optionally, the two abutting units are located at different positions on a same circumference; preferably, the two abutting units are located at two endpoints of a straight line passing through a center of a circle on a same circumference, and the two abutting units are 180° apart.

In a specific implementation, the two abutting units are located at different positions on a periphery of a shell of the pool cleaner where the rotating element is located. Preferably, the two abutting units are in symmetrical positions.

Optionally, the abutting units are connected in a swinging manner to the pool cleaner body, and the abutting units are fixedly connected to the swinging unit.

Optionally, the abutting unit includes a pre-abutting element (portion) and an abutting element (portion); the pre-abutting element (portion) is fixedly connected to the abutting element (portion); and the swinging of the swinging unit corresponds to the movement of the pre-abutting element (portion) and the abutting element (portion).

The elements (portions) are separate components or two parts of a same component.

In a specific implementation, (i) a point of action between the pre-abutting element (portion) and the stopping unit (the first stopping element) is not in a same vertical plane as (ii) a point of action between the abutting element (portion) and the stopping unit (the second stopping element).

Optionally, a lowest point of the pre-abutting element (portion) in a vertical direction is not at a same height as a lowest point of the abutting element (portion) in the vertical direction.

Optionally, the lowest point of the abutting element (portion) in the vertical direction is higher than the lowest point of the pre-abutting element (portion) in the vertical direction.

Optionally, the abutting element (portion) and/or the pre-abutting element (portion) are connected in a swinging manner to the pool cleaner body; The abutting element (portion) and/or the pre-abutting element (portion) are fixedly connected to the swinging unit.

In a specific implementation, the abutting element (portion) is located on an extension line of the pre-abutting element (portion) facing an inner side of the pool cleaner body.

Optionally, the pre-abutting element (portion) and the first stopping element interact with each other to be in interfered or detached positions; and the abutting element (portion) and the second stopping element interact with each other to be in interfered or detached positions.

Optionally, the pre-abutting element (portion) is provided with a main portion and an extension portion; and the extension portion is fixedly connected to the main portion (preferably the periphery) and extends towards the stopping unit.

Optionally, the main portion is provided with a through-hole and connected to a shaft of the pool cleaner body through the through-hole.

The extension portion interacts with (is interfered with or detached from) the stopping unit (the first stopping element).

In a specific implementation, the pre-abutting element (portion) is a (cylindrical, cubic, polyhedral, etc.) component with an internal through-hole; and the extension portion is formed downwards on a periphery the component. Preferably, the extension portion is a cylindrical structure (or the structure of the extension portion is set according to an actual need to interact with the first stopping element).

Optionally, a blocking portion and a through-portion are provided on a side of the abutting element (portion) facing the stopping device; the blocking portion and the through-portion are sequentially arranged along an axial direction; the through-portion and the stopping unit (the second stopping element) are at a position correspondence, such that the second stopping element passes through the through-portion during rotation; the blocking portion at least partially corresponds to the second stopping element, such that the blocking portion comes into contact with the second stopping element so as to restrict the rotation of the second stopping element.

In a specific implementation, the abutting element (portion) is an open component (cylindrical, cubic, or polyhedral, etc.) with an internal through-hole, or is a component (cylindrical, cubic, or polyhedral, etc.) with an internal through-hole; and the internal through-hole is connected in a swinging manner to the pool cleaner body through a shaft.

Optionally, a lower edge (a peripheral edge) of the component interacts with (is interfered with or detached from) the stopping unit (the second stopping element).

Optionally, the abutting element (portion) is fixedly connected to the pre-abutting element (portion), and the abutting element (portion) is located on an (inward) axial extension line of the pre-abutting element (portion) that is axially connected to the pool cleaner body.

When the swinging unit is in a vertical position relative to the pool cleaner, the lowest point of the abutting element (portion) is higher than the highest point of the second stopping element; and thus, the second stopping element passes through the abutting unit and the stopping unit rotates. In a specific implementation, the abutting element (portion) is a component with a central through-hole (such as a cylinder or cube with a central through-hole, or a half-cylinder or half-cube with a lower opening); the central through-hole is connected in a swinging manner to the pool cleaner body through a shaft; and when the swinging unit swings, the lower edge of the abutting element interacts (interferes) with the stopping unit (the second stopping element).

Optionally, the lowest point of the abutting element (portion) is higher than the lowest point of the extension portion of the pre-abutting element (portion).

Optionally, an upper side of the component with the central through-hole is fixedly connected to the swinging unit.

In a specific implementation, the abutting unit includes a pre-abutting element and an abutting element that are connected to each other; a blocking portion and a through-portion are provided on a side of the pre-abutting element facing the stopping unit; the blocking portion and the through-portion are sequentially arranged along an axial direction of the pre-abutting element; the through-portion and the second stopping element are at a position correspondence, such that the second stopping element passes through the through-portion during rotation; and the blocking portion at least partially corresponds to the first stopping element, such that the blocking portion comes into contact with the first stopping element so as to restrict the rotation of the first stopping element.

Further, the abutting element is located on a side of the pre-abutting element opposite to a blocking portion; the abutting element is connected in a swinging manner to the swinging element of the direction change device; when the blocking portion is detached from the first stopping element, the abutting element contacts the second stopping element to keep the direction change device in a relatively stationary state when the pool cleaner is traveling.

In a specific implementation, the swinging unit is a swinging element, preferably a U-shaped swinging element (plate).

Optionally, when the pool cleaner is in the moving state, the swinging unit is tilted backwards relative to the pool cleaner body; and
when the pool cleaner is in the obstructed state, the swinging unit is in a state selected from: (i) the swinging unit is tilted backwards relative to the pool cleaner body; and (ii) the swinging unit is vertical to the pool cleaner body.

Optionally, the swinging unit is restored from the tilted state to the vertical state through buoyancy, gravity, or elastic force.

A force that causes the swinging unit to be vertical to the pool cleaner body without other forces is defined as a restoring force.

Optionally, the force that causes the swinging unit to be vertical to the pool cleaner body comes from the restoring force.

The restoring force is selected from buoyancy, gravity, elastic force, or inertial force. In a specific implementation, a buoyancy element is provided on the swinging unit or at least a portion of the swinging unit is made of a buoyancy material (to provide a restoring force to the swinging unit).

In a specific implementation, a gravity element is provided on the swinging unit or at least a portion of the swinging unit is made of a gravity material (to provide a restoring force to the swinging unit).

In a specific implementation, an elastic element is provided at a connection between the swinging unit and the abutting unit or the pool cleaner body (to provide a restoring force to the swinging unit).

In a specific implementation, the restoring force is derived from a solution described in CN110409877A.

Optionally, the swinging unit includes at least one resistance plate, and the resistance plate is connected to the abutting unit in one of the following ways:
different resistance plates are connected to different abutting units, or one resistance plate is connected to different abutting units, or one resistance plate is connected to a same abutting unit.

Optionally, the resistance plate is fixedly connected to the abutting unit, and the abutting unit is connected in a swinging manner to the pool cleaner body.

Optionally, the swinging unit includes a U-shaped resistance plate, and two ends of the U-shaped resistance plate are respectively connected to different abutting units.

Optionally, the mechanical direction change structure includes:
a U-shaped resistance plate;
two abutting units, where each abutting unit includes a pre-abutting element (portion) and an abutting element (portion); and
a stopping unit, including a first stopping element and a second stopping element; where
two ends of the U-shaped resistance plate are respectively fixedly connected to one of the abutting units;
the abutting units are connected in a swinging manner to the pool cleaner body;
the first stopping element and the second stopping element are rotatable relative to the pool cleaner; and

During a rotation process of the stopping unit, the first stopping element and the pre-abutting element (portion) are in an interfered state or a detached state, and the second stopping element and the abutting element (portion) are in an interfered state or an abutted state.

Optionally, the end of the U-shaped resistance plate is fixedly connected to the abutting element (portion); the abutting element (portion) is fixedly connected to the pre-abutting element (portion); and the pre-abutting element (portion) is connected in a swinging manner to the pool cleaner body through a shaft.

Optionally, the first stopping element and the second stopping element are fixedly connected to a rotating water channel of the pool cleaner and are adjacent to each other.

Optionally, the first stopping element and the second stopping element are located on different circumferences, and the height of the first stopping element is different from the height of the second stopping element; and
the circumferences are centered on a rotation center of the rotating water channel.

Optionally, when the U-shaped resistance plate is in a vertical state, a lowest point of the pre-abutting element (portion) in a vertical direction is not at a same height as a lowest point of the abutting element (portion) in the vertical direction.

Optionally, the first stopping element is located on a periphery relative to the second stopping element.

Optionally, the pre-abutting element (portion) is located on a periphery relative to the abutting element (portion).

Optionally, the first stopping element and the second stopping element are located on different circumferences; a highest point of the first stopping element in a vertical direction is lower than a highest point of the second stopping element in the vertical direction; and
when the U-shaped resistance plate is in a vertical state, a lowest point of the abutting element (portion) in the vertical direction is higher than a lowest point of the pre-abutting element (portion) in the vertical direction.

Another aspect of the present application provides a pool cleaner, including the mechanical direction change structure according to any one of the above paragraphs.

Optionally, the pool cleaner includes a top shell and a bottom shell; the top shell and the bottom shell are detachably connected; the rotating water channel is provided in the top shell; and water flows through a water inlet of the bottom shell and is discharged through a water outlet of the water channel; and
when the pool cleaner is running, the rotating water channel rotates under an action of a power unit.

Optionally, the swinging unit and the abutting unit of the mechanical direction change structure are fixedly connected, and the abutting unit is connected in a swinging manner to the top shell.

Optionally, the top shell is provided with an opening corresponding to the water outlet of the rotating water channel.

In a specific implementation, when the abutting unit and the stopping unit are in a blocked state, the water outlet of the rotating water channel corresponds to the opening of the top shell, and the water flows out, applying a reactive force to the pool cleaner.

Optionally, the pool cleaner includes a power drive unit; and the power drive unit includes a motor and an impeller. When the motor starts, it drives the impeller to rotate. The water flows through the water inlet, a filter device, and the impeller to reach the rotating water channel. The water outlet of the corresponding discharge channel changes. The technical solution adopts a stopping unit and an abutting unit located on the swinging element. The stopping unit is rotatably connected to the pool cleaner body through the rotating element, and the stopping device rotates with the rotation of the rotating element. The swinging element is connected to the shell of the pool cleaner and is swingable relative to the shell. Through the rotation of the stopping unit, the stopping unit comes into contact or detaches from the abutting unit. In the traveling assembly of the pool cleaner travel, the stopping element is in contact with the abutting assembly. When the pool cleaner encounters a wall or an obstacle, the swinging element is restored to achieve the direction change. The design features a simple structure, convenient mounting, and smooth operation, and eliminates the need for an auxiliary direction change through an electrical control part. The stopping rotation makes the direction change of the pool cleaner more stable, reduces energy consumption, and makes the direction change more precise. The first stopping element and the second stopping element of the stopping unit cooperate with the pre-abutting element (portion) and the abutting element (portion) of the abutting unit, solving the problem that the movement of the pool cleaner is obstructed (such as due to a wall).

In addition, according to the structure of the swinging unit, the stopping unit is provided with a first stopping element and a second stopping element. The first stopping element and the second stopping element are adjacent to each other (located on the same side of the rotating element). The height of the first stopping element is smaller than that of the second stopping element. In this way, the abutting assembly crosses the first stopping element and comes into contact with the second stopping element, such that the second stopping element is in contact with the abutting assembly during the travel process of the pool cleaner. The design ensures that the pool cleaner is in a stable state during travel, avoiding the swinging element from detaching from the stopping element in case of an excessive swinging angle.

### BRIEF DESCRIPTION OF THE DRAWINGS

FIG. 1 is a structural diagram of a pool cleaner according to Embodiment 1 of the present disclosure;

FIG. 2 is a structural diagram of the pool cleaner (with a top shell removed) according to Embodiment 1 of the present disclosure;

FIG. 3 is a structural diagram of the pool cleaner (with the top shell removed and a swinging unit in a vertical state) according to Embodiment 1 of the present disclosure;

FIG. 4 is a structural diagram of the pool cleaner (with the swinging unit in a tilted state) according to Embodiment 1 of the present disclosure;

FIG. 5 is a structural diagram of the pool cleaner (with the swinging unit in a tilted state) according to Embodiment 1 of the present disclosure;

FIG. 6 is a structural diagram of a mechanical direction change structure according to Embodiment 1 of the present disclosure;

FIG. 7 is a structural diagram of a pool cleaner according to Embodiment 2 of the present disclosure;

FIG. 8 is a structural diagram of a mechanical direction change structure according to Embodiment 2 of the present disclosure; and

FIG. 9 is a structural diagram of the pool cleaner (with a swinging unit in a tilted state) according to Embodiment 2 of the present disclosure.

### REFERENCE NUMERALS

1. swinging unit; and 2. connecting shaft;
3. top shell; 31. upper top shell; and 32. lower top shell;
4. abutting unit; 41. abutting element (portion); and 42. pre-abutting element (portion);
400. abutting body (main portion); 401. through-portion; and 402. blocking portion (extension portion);
5. stopping unit; 50. first stopping element; and 51. second stopping element; and
7. rotating water channel; 70. water outlet of rotating water channel; and 8. connecting element.

### DETAILED DESCRIPTION OF THE EMBODIMENTS

The present disclosure is described in more detail below with reference to the drawings and specific embodiments.

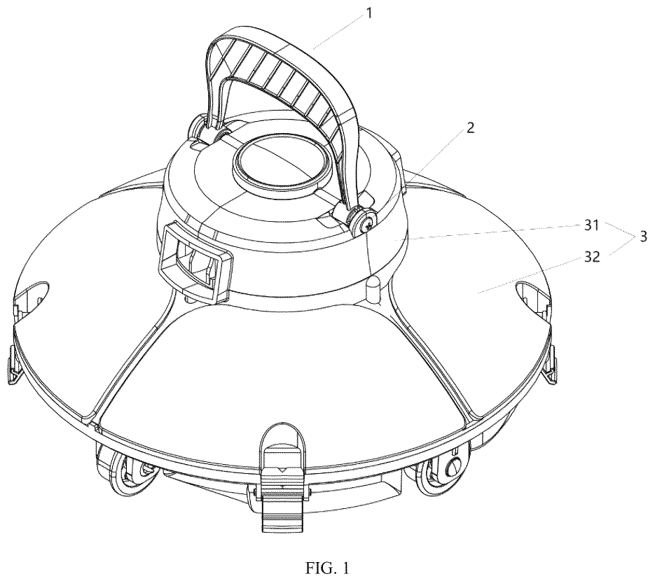

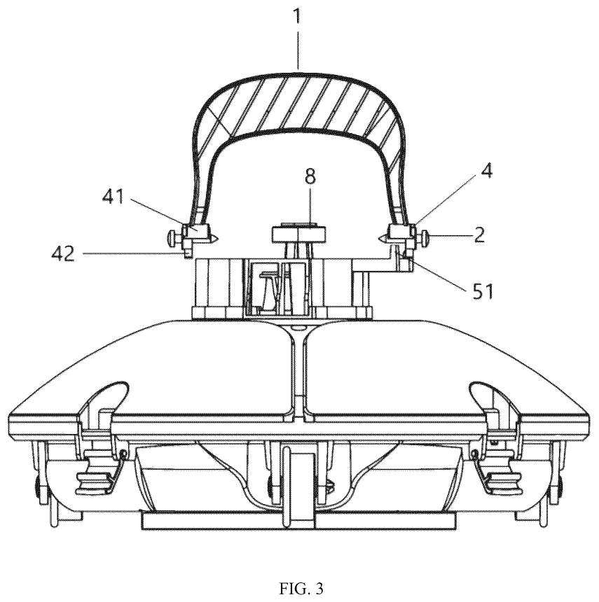

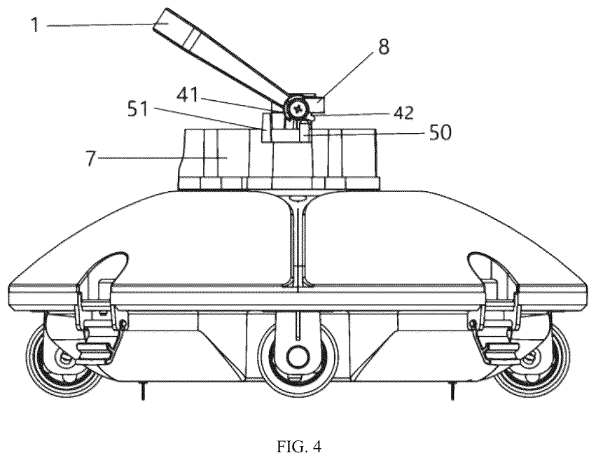

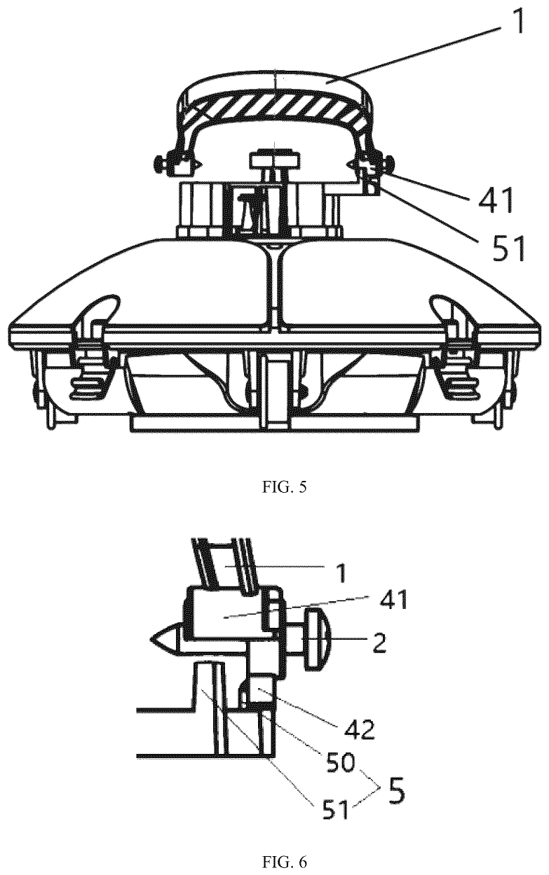

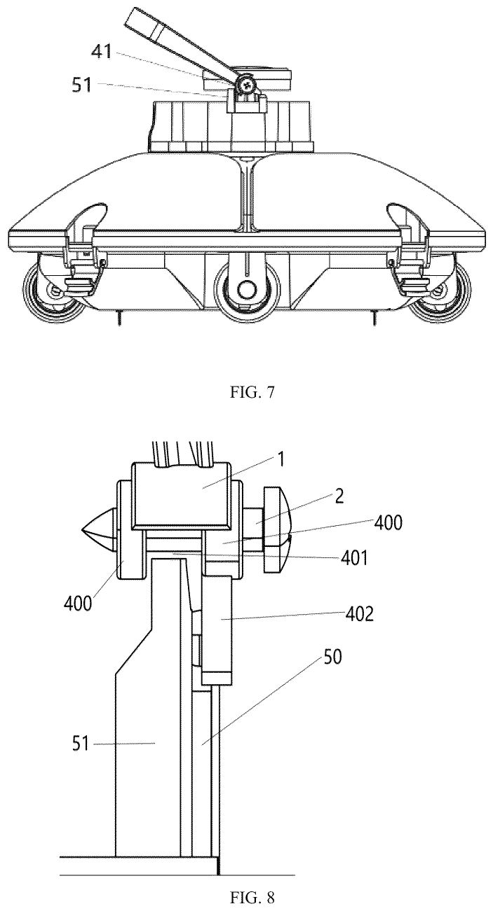

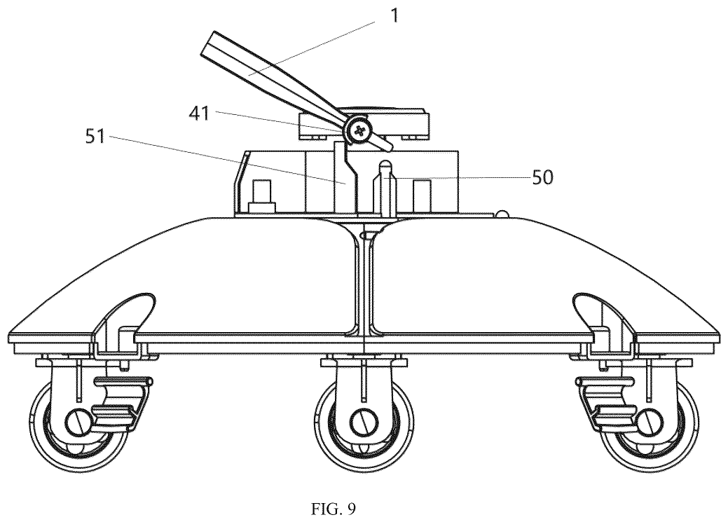

FIGS. 1 to 9 illustrate structural diagrams of some embodiments of the present disclosure, which relate to a mechanical direction change structure for a pool cleaner, and a pool cleaner, for achieving a direction change when the movement of the pool cleaner inside a pool is obstructed, such as when the pool cleaner encounters a wall or an obstacle. In some embodiments of the present disclosure, in the mechanical direction change structure, the stopping unit 5 and abutting unit 4 are first in a blocked (interfered) state. Then, it is determined if there is actual water flow thrust, and a next action is performed based on a determination result. When the next action is performed, the stopping unit 5 and the abutting unit 4 cooperate with each other to achieve the direction change of the pool cleaner. The stopping unit 5 is rotatable relative to the stopping unit 4 (the stopping unit 4 is connected to a pool cleaner body and is swingable relative to the pool cleaner body. For example, the stopping unit 4 is connected to a shell of the pool cleaner and is swingable back and forth relative to the shell of the pool cleaner. The stopping unit 5 is connected to the pool cleaner body and is rotatable relative to the pool cleaner body/stopping unit 4. For example, the stopping unit 5 is connected to a rotating element of the pool cleaner and rotates with the rotation of the rotating element). During a rotation process of the stopping unit 5, the stopping unit 5 comes into contact with the abutting unit 4 and is blocked by the abutting element 4. Alternatively, the stopping unit 5 detaches from the abutting unit 4, and the stopping unit 5 continues to rotate, in order to achieve the direction change of the pool cleaner. For example, when the pool cleaner starts working, the stopping unit 5 rotates (due to a drive device). When the stopping unit rotates to a position of the abutting unit 4, the stopping unit and the abutting unit are in an interfered state. The position of the abutting unit 4 corresponds to a position relationship between a water outlet of the pool cleaner and a water outlet of a water channel. That is, when the stopping unit 5 is blocked at the position of the abutting unit 4, the water outlet of the water channel corresponds to the water outlet of the pool cleaner, and the water outlet of the pool cleaner sprays water. Under the thrust of water, the pool cleaner moves in one direction. The resistance of water acts on the swinging unit, causing the swinging element to tilt backwards, and the abutting unit 4 maintains a blocked state. When the movement of the pool cleaner is obstructed (such as when the pool cleaner encounters a wall or an obstacle), the resistance of water disappears, and the swinging unit 1 is restored. The abutting unit 4 and the stopping unit 5 are detached, and the stopping unit 5 continues to rotate. The above process is repeated to complete the direction change. Thus, an automatic direction change is achieved based on the coordinated blocked or detached state between the stopping unit 5 and the abutting unit 4, without the need for an auxiliary direction change through an electrical control part. The design features a simple structure, convenient mounting, and high work efficiency.

The present disclosure is described in detail below based on some specific embodiments.

### Embodiment 1

FIG. 1 shows a pool cleaner with a mechanical direction change structure. The pool cleaner includes top shell 3 and a bottom shell (not shown in the figure). The top shell 3 is fixedly connected to the bottom shell. The mechanical direction change structure is provided on the top shell 3 (the top shell 3 includes upper top shell 31 and lower top shell 32, and the upper top shell 31 and the top shell 32 are fixedly connected). The swinging unit 1 (a U-shaped swinging plate) is connected to the top shell in a swinging manner through connecting shaft 2. A rotating water channel is provided inside the upper top shell 31 and connected to the upper top shell 31 through connecting element 8. When the pool cleaner is running, a power drive unit (such as a motor and an impeller) begins to work. When the motor starts, it drives the impeller to rotate to suck in sewage from a pool. The sewage in the pool enters a filtering unit in the bottom shell through a water inlet (bottom water inlet) of the pool cleaner. Filtered water enters the rotating water channel 7. When the water outlet 70 of the rotating water channel corresponds to an opening of the top shell, the filtered water is discharged from the water outlet through the opening of the top shell to drive the pool cleaner to move. During the movement of the pool cleaner in the pool, the swinging unit 1 tilts backwards relative to the pool cleaner due to the rotational thrust of the stopping unit and the resistance of the water flow. Thus, the stopping unit is in a relatively stationary state relative to a pool cleaner body, and the water outlet 70 of the rotating water channel 7 connected to the stopping unit corresponds to the opening of the top shell. The water outlet sprays out water, causing the pool cleaner to move and clean.

During a cleaning process in the pool, generally, after a certain period of movement (depending on the actual situation), the pool cleaner may experience movement obstruction (for example, the pool cleaner may encounter a pool wall, a ladder, or the uneven bottom of the pool).

When the movement of the pool cleaner is obstructed, the resistance of water to the swinging unit 1 disappears, and the swinging unit 1 is restored to a vertical state. At this point, the rotating water channel is rotatable until the stopping unit interacts with another abutting unit. The water outlet of the rotating water channel corresponds to another opening of the upper top shell 31. The water discharge direction changes, causing the pool cleaner to move in another direction and getting out of the obstruction trouble. The swinging unit 1 is once again tilted backwards, allowing the pool cleaner to continue moving and cleaning.

In this embodiment, when the pool cleaner is in motion, the swinging unit 1 is subject to resistance from water. Second stopping element 51 is at a position of interfering (blocking) with abutting element 41. The swinging unit 1 tilts relative to the pool cleaner body.

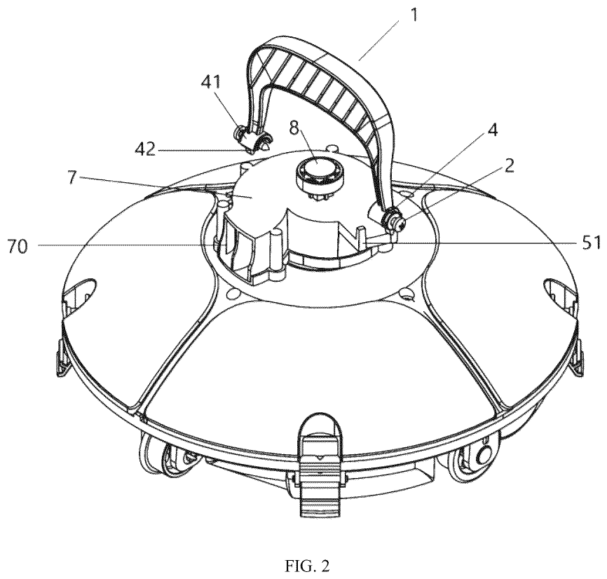

As shown in FIGS. 2 to 6, in this embodiment, the mechanical direction change structure (see FIG. 6 for a specific enlarged view) includes the swinging unit 1, the abutting unit 4, and the stopping unit 5. In this embodiment, the swinging unit 1 is a U-shaped swinging element. The stopping unit 5 includes two stopping elements, namely the first stopping element 50 and the second stopping element 51. The abutting unit 4 includes pre-abutting element 42 and the abutting element 41.

The first stopping element 50 and the second stopping element 52 are fixedly connected to the rotating water channel 7 through an extension plate. That is, the first stopping element and the second stopping element are provided on an extension portion of a periphery of the rotating water channel 7 and are vertically facing upwards to interfere (block) with the abutting unit. The first stopping element 50 and the second stopping element 51 are located at different positions on a same circumference. When the rotating water channel 7 rotates, it passes through the first stopping element 50 and the second stopping element 51 in sequence. The second stopping element 51 is higher than the first stopping element 50, and the first stopping element 50 is located on the periphery relative to the second stopping element 51. The specific shapes of the first stopping element 50 and the second stopping element 51 are set according to actual needs. For example, the first stopping element and the second stopping element can be set in common cylindrical or polyhedral shapes, or be provided with slopes as needed.

The pre-abutting element 42 is connected to the upper top shell 31 in a swinging manner through the connecting shaft 2. The pre-abutting element includes a main portion and an extension portion. The main portion is provided therein with a through-hole for the connecting shaft 2 to pass through and connect the upper top shell 31. The extension portion is formed below the main portion. It is configured to interact with the first stopping element 50 and can be in an interfered/blocked state. According to actual needs, specifically, the pre-abutting element 42 can be a main body or a polyhedron with a central through-hole, with a periphery extending downwards to form a column or polyhedron, etc. The abutting element 41 and the pre-abutting element 42 are fixedly connected (can be integrally formed according to actual needs). The abutting element 41 is located on an extension line from the pre-abutting element 42 to an inner side of the cleaner body, and the connecting shaft 2 passes through the abutting element 41. The abutting element 41 can be provided with a hollow arched cross-section according to actual needs. That is, it can be set as a semi-hollow cylinder, a polyhedron, a hollow cylinder, a polyhedron or a similar structure, and its lowest point is higher than the pre-abutting element 42. A lower edge of the abutting element 41 can interact with the second stopping element 51 and be in an interfered/blocked state (such as when the pool cleaner is in motion). Besides, when the pre-abutting element 42 is interfered (blocked) by the first stopping element 50, the abutting element 41 and the second stopping element 51 are in a detached state. When the movement of the pool cleaner is obstructed and the pre-abutting element 42 interferes with the first stopping element 50, the rotational force applied by the rotating water channel 7 to the stopping unit can cause the pre-abutting element 42 to detach from the first stopping element 50. Due to the rotational force, the stopping unit gradually rotates and causes the first stopping element 50 to rotate and overcome the blocking of the pre-abutting element 42, thereby causing the pre-abutting element 42 to detach from the first stopping element 50. When the pre-abutting element 42 and the first stopping element 50 gradually change from the blocked state to the detached state, if the pre-abutting element 42 and the first stopping element 50 detach from each other, the abutting element 41 and the second stopping element 51 are in an interfered state. When the movement of the pool cleaner is obstructed, the resistance of water disappears, that is, the swinging unit 1 is no longer subject to resistance of water. The swinging unit 1 is restored to a vertical state due to a restoring force (such as buoyancy, where the swinging element is made of a buoyancy material). The abutting unit 4 and the stopping unit 5 detach, and the stopping unit continues to rotate until it abuts with the abutting unit on the other side. For example, the first stopping element 50 interferes with the pre-abutting element on the other side, or the second stopping element 51 interferes with the abutting element on the other side. The water outlet of the rotating water channel corresponds to another opening of the upper top shell 31, and the water discharge direction changes compared to the previous direction. In this way, the pool cleaner moves in a different direction and overcomes the problem of movement obstruction.

The swinging unit 1 is a U-shaped swinging plate, with two ends connected to different abutting units. The abutting units at the two ends have the same structure, and they are connected to the U-shaped swinging element and the cleaner body (top shell) in the same way.

In a specific implementation of a working state, a direction change process of the pool cleaner due to the mechanical direction change structure is as follows. The pool cleaner is working, and the stopping unit is rotating. When the stopping unit rotates to the first abutting unit, the first stopping element 50 and the pre-abutting element 42 come into contact and are in a blocked state, thereby limiting the rotation of the stopping unit. The water outlet of the water channel corresponds to one of the multiple water outlets of the pool cleaner, and the impeller inside the pool cleaner body rotates to suck in the sewage at the bottom of the pool cleaner. The sewage enters a filter box inside the bottom shell for filtration. The filtered water enters the rotating water channel 7. It flows along the water channel and is discharged from the water outlet of the rotating water channel 7. At this point, if the movement of the pool cleaner is obstructed due to a wall or an obstacle and the first stopping element 50 and the pre-abutting element 42 are in or approach an interfered state, then under the continuous action of the rotational thrust of the stopping unit, the swinging unit 1 swings (for example, the swinging unit changes from a vertical state to a tilted state or from a tilted state to a more inclined state). Here the abutting element 41 tends to be in a blocked state (i.e. the abutting element 41 and the second stopping element 51 tend to be in an interfered/blocked state). The rotational force of the stopping unit is applied to the pre-abutting element 42 through the first stopping element 50. Due to the rotational thrust, the first stopping element 50 detaches from the pre-abutting element 42. The stopping unit 5 rotates, and the second stopping element 51 moves towards the abutting element 41. The second stopping element 51 and the abutting element 41 are in an interfered/blocked state. The movement of the pool cleaner is obstructed, and there is no resistance of water pressing against the swinging unit 1. Then the swinging unit 1 is restored due to a restoring force (which can be buoyancy, elastic force, gravity, inertial force, etc.) (for example, the swinging element 1 is restored to a vertical state). The second stopping element 51 detaches from the abutting element 41, and the second stopping element 51 crosses the abutting element 41. The first stopping element 50/second stopping element 51 is in a detached state from the pre-abutting element 42/abutting element 41. The stopping unit continues to rotate. When the stopping unit rotates to another abutting position, the first stopping element 50 and the pre-abutting element 40 at that abutting position are in a blocked state. Due to the rotation of the stopping unit, the water outlet of the water channel changes to another one that corresponds to another water outlet of the pool cleaner. In this way, the pool cleaner changes its direction of travel and moves away from the pool wall or obstacle, achieving the purpose of direction change and travel.

In a specific implementation of another working state, a direction change process of the pool cleaner under the mechanical direction change effect is as follows. The pool cleaner is working, and the stopping unit 5 is rotating. When the stopping unit rotates to an abutting position, the first stopping element 50 and the pre-abutting element 42 come into contact and are in blocked positions. The water outlet of the water channel corresponds to a water outlet of the pool cleaner, and the water outlet of the pool cleaner sprays water, thereby driving the pool cleaner to move. During the movement of the pool cleaner (where there is a thrust generated by resistance of water), due to the rotational thrust of the stopping unit 5 and the resistance of water, the swinging unit 1 swings and drives the first stopping element 50 to detach from the pre-abutting element 42. The second stopping element 51 comes into contact with the abutting element 41, and the abutting element 41 blocks the rotation of the second stopping element 51. The second stopping element 51 interferes (is in a blocked state) with the abutting element 41 (for example, the swinging element 1 is in (maintains) a tilted state). The rotation of the rotating water channel 7 is restricted, and the stopping unit stops rotating. Under the continuous action of the resistance of water, the swinging element 1 maintains a tilted state, causing the abutting element 41 to maintain the blocked state, and the pool cleaner moves in one direction. When the movement of the pool cleaner is obstructed (due to a wall or an obstacle), the resistance of water disappears. That is, the thrust of the water flow acting on the swinging unit 1 disappears. The swinging unit 1 is restored due to a restoring force (which can be buoyancy, elastic force, gravity or inertial force, etc.) (it is restored from an inclined state to a vertical state). The second stopping element 51 detaches from the abutting element 41, and the second stopping element crosses the abutting element 41. The rotating water channel 7 rotates, and the stopping unit rotates to the position of another abutting unit. The water outlet of the water channel rotates to another water outlet of the pool cleaner. The water outlet of the pool cleaner sprays water, thereby completing the direction change.

The above process is repeated to achieve the travel and direction change of the pool cleaner inside the pool.

### Embodiment 2

In this embodiment, the structure of the pool cleaner body is the same as that in Embodiment 1, except for a difference in the mechanical direction change structure.

As shown in FIGS. 7 to 9, a mechanical direction change structure for a pool cleaner is described as follows.

The mechanical direction change structure is provided on the pool cleaner body, and includes: abutting units 4, and at least one stopping unit 5 rotatable relative to the pool cleaner body/abutting unit 4. When the pool cleaner is traveling, the stopping unit 5 contacts the abutting unit 4 to keep the direction change device relatively stationary relative to the pool cleaner body. The pool cleaner gradually stabilizes and reaches a relatively stationary state during movement. During a direction change process of the pool cleaner, the stopping unit 5 gradually detaches from the abutting unit 4 and rotates relative to the abutting unit 4. When the stopping unit is blocked by another abutting unit, the pool cleaner moves and completes a direction change. Through the rotation of the stopping unit 5, the stopping unit 5 contacts or detaches from the abutting unit 4, causing the swinging unit to remain tilted or to be restored to a vertical state, thereby achieving the direction change of the pool cleaner.

The pool cleaner body includes an impeller and rotating water channel 7. The impeller is connected to a motor inside the pool cleaner and serves as a drive device to suck in water from the bottom of the pool cleaner. The rotating water channel 7 is rotatably connected to a shell (top shell) of the pool cleaner. The impeller is located inside the rotating water channel 7 and coaxial with the rotating water channel 7. When the impeller rotates, it drives the sucked-in water to rotate along the rotating water channel 7, thereby driving the rotating water channel 7 to rotate. Thus, the water is discharged from a water outlet of the rotating water channel 7. The rotating water channel 7 is a snail shell structure.

In this embodiment, the stopping unit 5 is provided on an extension portion of the rotating water channel 7 of the pool cleaner and rotates with the rotating water channel 7. When the rotating water channel 7 rotates, it drives the stopping unit 5 to rotate. The stopping unit 5 is fixedly connected to the extension portion (extension plate) of the rotating water channel 7, and the stopping unit 5 is located close to an outer edge of the extension plate of the rotating water channel 7, such that the stopping unit 5 can cooperate with the abutting unit 4 to achieve contact or detachment during rotation. During the operation of the pool cleaner, the impeller is always in a rotating state due to the motor, which drives the rotating water channel 7 to rotate. The stopping unit 5 rotates with the rotating water channel. During the rotation process, the stopping unit 5 is blocked by the abutting unit 4 and stops rotating. The water outlet of the rotating water channel 7 corresponds to a water outlet on the shell of the pool cleaner. The water outlet sprays water in one direction to propel the pool cleaner. When the stopping unit 5 gradually detaches from the abutting unit 4, the stopping unit 5 is no longer blocked and rotates. The rotating water channel 7 rotates, and the water outlet of the water channel rotates to another water outlet of the pool cleaner. The water outlet of the pool cleaner sprays water and propels the pool cleaner to move in another direction, thereby achieving the direction change.

There are at least two abutting units 4. When the pool cleaner stops moving and changes its direction, the swinging unit is restored to a vertical state. During this process, the stopping unit 5 gradually detaches from the abutting unit 4. Under the rotational action of the rotating water channel 7, the stopping unit 5 rotates to another abutting position. The abutting unit 4 blocks the stopping unit 5, and the stopping unit 5 stops rotating. The pool cleaner changes its direction and travels. During the travel process of the pool cleaner, the swinging unit device is subject to the resistance of water and a force or restoring force generated by the rotation of the stopping unit 5. Due to force balance, the swinging unit remains relatively stationary relative to the pool cleaner body. During the direction change process, the stopping unit 5 rotates with the rotation of the rotating water channel 7. At each abutting position, the stopping unit 5 is blocked by the abutting unit 4 at that abutting position. In this way, the pool cleaner changes its direction and walks.

The pool cleaner body further includes a shell. The shell of the pool cleaner includes top shell 3 and bottom shell (the top shell includes upper top shell 31 and lower top shell 32, and the upper top shell 31 and the lower top shell 32 fixedly connected). The top shell and the bottom shell are connected to each other. In this embodiment, the abutting unit is provided on the top shell 3. The direction change device (the abutting unit and the swinging unit) is rotatably connected to the top shell 3 and is swingable relative to the top shell 3. The rotating water channel 7 is rotatably connected to the top shell. The direction change device includes the abutting unit 4 and the swinging unit 1. The swinging unit 1 is rotatably connected to the upper top shell 31 through connecting shaft 2 (rotating shaft). The abutting unit 4 is connected to the swinging element unit, and the abutting unit 4 swings with the swinging of the swinging unit 1.

A top of the rotating water channel 7 is provided with a connecting element. The rotating water channel 7 is connected to the upper top shell 31 through the connecting element 8. The abutting unit 4 is connected to the connecting element 8 in a swinging manner through the connecting shaft 2. The connecting element 8 is fixedly connected to the upper top shell 31 or is a part of the top shell 3. The connecting element 8 (fixing element) can protrude from the upper top shell 31.

The swinging unit 1 is a swinging element. The swinging element can be a plate-shaped structure, U-shaped structure, or another structure. The structure of the swinging element is et according to actual needs, and is not specifically limited herein.

According to the structure of the swinging unit 1 and the setting of the abutting unit 4, the stopping unit 5 has different structures and settings.

In this embodiment, the swinging unit 1 is a U-shaped swinging plate. Two ends of the U-shaped swinging plate are respectively fixedly connected to one of the abutting units 4.

In this embodiment, as shown in FIGS. 7 to 9, the structure of the stopping unit is as follows. The stopping unit 5 includes first stopping element 50 and second stopping element 51. The first stopping element 50 and the second stopping element 51 are located on a same side of the rotating water channel 7, and are sequentially arranged along a circumferential direction of the rotating water channel 7. During the travel and/or direction change of the pool cleaner, the abutting assembly first contacts the first stopping element. After being subjected to the resistance of the water flow, the abutting element crosses the first stopping element and comes into contact with the second stopping element. Along a radial direction of the rotating water channel 7, a distance between the second stopping element 51 and an axis of the rotating water channel 7 can be smaller than a distance between the first stopping element 50 and the axis of the rotating water channel 7. Alternatively, the distance between the second stopping element 51 and the axis of the rotating element 7 may be greater than the distance between the first stopping element 50 and the axis of the rotating water channel 7. Alternatively, the distance between the second stopping element 51 and the axis of the rotating water channel 7 can be equal to the distance between the first stopping element 50 and the axis of the rotating water channel 7. The distance is set according to actual needs, and is not specifically limited herein. Preferably, in this embodiment, the distance between the second stopping element 51 and the axis of the rotating water channel 7 is less than the distance between the first stopping element 50 and the axis of the rotating water channel 7. The first stopping element 50 and the second stopping element 51 are fixedly provided at any position on a bottom plate of the rotating water channel 7. The first stopping element 50 is adjacent to the second stopping element 51. There is a certain circumferential clearance between the first stopping element 50 and the second stopping element 51 in the circumferential direction of the rotating water channel 7, and there is a certain radial clearance between the first stopping element 50 and the second stopping element 51 in the radial direction of the rotating water channel 7. The first stopping element 50 and the second stopping element 51 are staggered through the circumferential and radial clearances. When the swinging unit 1 is restored to a vertical state, the abutting unit 4 is located in a space formed by the circumferential and clearances, extending out of that space and freely swinging within that space. According to the working state of the pool cleaner and whether the swinging unit 1 is pushed by the water flow, the abutting unit 4 can come into contact with the first stopping element 50 or the second stopping element 51. The abutting unit 4 blocks the first stopping element 50 or the second stopping element 51, thereby blocking the rotation of the rotating water channel 7, such that the rotating water channel 7 no longer rotates. Therefore, the swinging element 1 remains relatively stationary with the rotating water channel 7.

A height of the second stopping element 51 can be greater than a height of the first stopping element 50. Alternatively, the height of the second stopping element 51 is greater than the height of the first stopping element 50. Alternatively, the height of the second stopping element 51 is consistent with the height of the first stopping element 50. The height is set according to actual needs, and is not specifically limited herein. In this embodiment, preferably, the height of the second stopping element 51 is greater than the height of the first stopping element 50.

In this embodiment, the position of the stopping unit is determined according to the position of the water outlet of the rotating water channel 7. The stopping unit is located at one side of the water outlet to avoid the water discharge from being interfered by the stopping unit. Meanwhile, the position of the stopping unit can be set according to the position of the abutting unit 4 and the corresponding relationship between the water outlet of the water channel and the water outlet of the pool cleaner. When the stopping unit is blocked at the position of the abutting unit 4, the water outlet of the water channel corresponds to the water outlet of the pool cleaner. The water outlet of the pool cleaner discharges water, causing the pool cleaner to change its direction and travel.

The first stopping element 50 and the second stopping element 51 are cylindrical structures and are arranged along an axial direction of the rotating water channel 7. The first stopping element 50 is parallel to the axis of the rotating water channel 7, and the second stopping element 51 is also parallel to the axis of the rotating water channel 7. The cross-sectional shapes of the first stopping element 50 and the second stopping element 51 can be circular, square, elliptical, or other irregular shapes, which are set according to actual needs and are not specifically limited herein. The height of the second stopping element 51 is greater than that of the first stopping element 50, such that the abutting unit 4 is subjected to the rotational thrust of the first stopping element 50 and the thrust of the water flow. The abutting unit 4 crosses the first stopping element 50 and comes into contact with the second stopping element 51. In this way, the second stopping element 51 is blocked by the abutting unit 4, and the abutting unit 4 maintains a relatively stationary state with the second stopping element 51. In this way, the pool cleaner travels.

In this embodiment, the abutting unit 4 is fixedly connected to the swinging unit 1, and the abutting unit 4 is connected to the connecting shaft (rotating shaft) 2. Due to the rotating shaft 2, the abutting unit 4 rotates relative to the shell. The abutting unit 4 includes pre-abutting element 40 and abutting element 41 that are connected to each other. The pre-abutting element 40 and the abutting element 41 are matched with the first stopping element 50 or the second stopping element 51 to block the rotation of the first stopping element 50 or the second stopping element 51. A side of the pre-abutting element 42 facing the stopping device 5 is provided with blocking portion 402 and through-portion 401. The blocking portion 402 and the through-portion 401 are sequentially arranged along an axial direction of the pre-abutting element 42. The position of the through-portion 401 corresponds to the position of the second stopping element 51, such that the second stopping element 51 can pass through the through-portion 401 when rotating. The pre-abutting element 40 will not interfere with the rotation of the second stopping element 51. When the swinging unit 1 is in a vertical state, the blocking portion 402 at least partially corresponds to the first stopping element 50, such that the blocking portion 402 comes into contact with the first stopping element 50. The blocking portion 402 achieves an abutted state between the pre-abutting element 40 and the first stopping element 50, and blocks the rotation of the first stopping element 50.

When the pre-abutting element 42 is mounted, the pre-abutting element 40 is coaxial with the rotating shaft 2. The pre-abutting element 40 includes abutting body 400. The abutting body 400 is a columnar structure with a through-hole in an axial direction. The rotating shaft 2 can be inserted into the through-hole and connected to the abutting body 400. The rotating shaft 2 is in an interference fit with the through-hole. Alternatively, the rotating shaft 2 is provided with external threads and the through-hole is provided with internal threads. The abutting body 400 is connected to the rotating shaft 2 through threaded or other means. The connection means depends on actual needs, and is not specifically limited herein. Through-portion 401 is provided on the side facing the stopping unit against the abutting body 400. The through-portion 401 is a groove structure, formed by a depression of an outer surface of the abutting body 400 towards the axial direction of the abutting body 400. A size of the through-portion 401 is larger than a size of the second stopping element 51. When the swinging unit 1 is in a vertical state and the second stopping element 51 rotates, the second stopping element 51 can pass through the through-portion 401. The blocking portion 402 is provided on a side of the abutting body 400 facing the stopping unit. The blocking portion 402 is located at one side of the through-portion 401, and the position of the blocking portion 402 roughly corresponds to the position of the first stopping element 50. The blocking portion 402 has a plate-like structure. One end of the blocking portion 402 is fixedly connected to the abutting body 400. Preferably, the fixed connection is achieved by means of integrated molding. The blocking portion 402 is provided along a length direction of the first stopping element 50. When the swinging unit 1 is in a vertical state, the blocking portion 402 is parallel to the first stopping element 50. A length of the blocking portion 402 is greater than a distance from a top of the first stopping element 50 to the abutting body 400. That is, in a vertical direction, there is an overlap between projection of the blocking portion 402 and projection of the first stopping element 50, such that when the first stopping element 50 rotates, the blocking portion 402 blocks the first stopping element 50. The blocking portion 402 is in contact with the first stopping element 50 to block the rotation of the rotating water channel 7. The rotating element 7 remains relatively stationary with the swinging unit 1.

In addition, the structure of the abutting body 400 can also be as follows. The abutting body 400 includes a first connecting element and a second connecting element. The first connecting element and the second connecting element are fixedly connected to the rotating shaft 2 and both are circular structures with a certain length. When the first connecting element and the second connecting element are provided at an interval on the rotating shaft 2, the interval between the first connecting element and the second connecting element forms the structure of the through-portion 401. The blocking portion 402 is fixedly connected to the second connecting element and is located on a side of the second connecting element facing the first stopping element 50.

The abutting element 41 is located on a side of the pre-abutting element 40 opposite to the blocking portion 402. The abutting element 41 is connected to the swinging unit 1 of the direction change device. When the blocking portion 402 detaches from the first stopping element 50, the abutting element 41 comes into contact with the second stopping element 51. In this way, when the pool cleaner is traveling, the abutting element 41 blocks the second stopping element 51 to make it remain a relatively stationary state during the travel process of the pool cleaner. The abutting element 41 is opposite to the blocking portion 402. The abutting element 41 plays a connecting role and is fixedly connected to the swinging unit 1, thereby connecting the swinging element 1 to the abutting unit 4. Meanwhile, the abutting element 41 plays a blocking role. When the blocking portion 402 detaches from the first stopping element 50, the abutting element 41 contacts the second stopping element 51 to block the rotation of the second stopping element 51. The abutting element 41 is a curved structure, with a cross-sectional shape adapted to the shape of an outer side of the pre-abutting element 40, and protrudes from the outer side of the pre-abutting element 40. The abutting element 41 is fixedly connected to the pre-abutting element 40. An area of the abutting element 41 covering the pre-abutting element 40 is not less than half of an outer surface area of the pre-abutting element 40. After the blocking portion 402 detaches from the first stopping element 50, the abutting element 41 can partially come into contact with the second stopping element 51 to block the rotation of the second stopping element 51.

During the travel process of the pool cleaner, the tilting direction of the swinging unit 1 is always opposite to the travel direction of the pool cleaner. The swinging unit 1 maintains a balanced state through a combined effect of its own buoyancy, the resistance of the water, and the contact and coordination between the stopping unit and the abutting unit 4. When the pool cleaner stops travelling due to a wall or an obstacle, the resistance of the water disappears. The swinging unit 1 is restored to a vertical state under its own buoyancy. The rotating water channel 7 rotates, and the stopping unit rotates accordingly, causing the pool cleaner to change its direction. The direction of the resistance of the water to the swinging element 1 changes, and the tilt direction of the swinging element 1 changes. During the rotation process, the stopping unit needs to come into contact with and be blocked by the abutting unit 4 located in another abutting position, thereby causing the swinging element 1 to tilt. Therefore, in this embodiment, the direction change device is provided with two abutting units 4. The two abutting units 4 are located at two sides of the rotating water channel 7, and the swinging unit 1 is a U-shaped structure. Preferably, the two abutting units 4 are symmetrically arranged at the sides of the rotating water channel 7, and the two abutting units 4 are located on a same straight line. The two abutting units 4 are respectively located at two abutting positions. The stopping device 5 can rotate 180° to make contact with the abutting unit 4 at one of the abutting positions of the swinging unit 1.

A pool cleaner includes the mechanical direction change structure. The swinging unit 1 is rotatably connected to the top shell 3 through the rotating shaft 2. The swinging unit 1 is located outside the top shell 3, and the stopping unit is located inside the top shell 3. The contact or detachment between the stopping device 5 and the abutting unit 4 is carried out inside the top shell 3. The rotating water channel 7 is located inside the top shell 3, and is rotatably connected to the top shell 3 through rotating element 8. The top shell 3 is provided with two or more water outlets for water discharge.

During a travel process of the pool cleaner that is cleaning the pool, the swinging element unit achieves force balance through a combined effect its own buoyancy, the resistance of the water, and the contact and coordination between the stopping unit and the abutting unit 4. In this way, the swinging unit 1 remains relatively stationary relative to the pool cleaner body. The pool cleaner has the following two working states.

In a specific implementation of one working state, a direction change process of the pool cleaner due to the mechanical direction change mechanism is as follows. The pool cleaner is working, and the stopping unit is rotating. When the stopping unit rotates to a first abutting position, the first stopping element 50 and the pre-abutting element 42 come into contact and are in a blocked state. The blocking portion 402 is in contact with the first stopping element 50, and the blocking portion 402 restricts the rotation of the first stopping element 50. The water outlet of the water channel corresponds to one of the multiple water outlets of the pool cleaner. The impeller rotates to suck in the sewage from the bottom of the pool cleaner. The sewage enters the filter box inside the bottom shell for filtration. The filtered water enters the rotating water channel 7 and flows along the rotating water channel 7. The water drives the rotating water channel 7 to rotate, and is discharged from the water outlet of the rotating water channel 7. At this point, if the pool cleaner is in a non-moving state due to a wall or an obstacle, under the continuous action of the rotating thrust of the stopping unit, the swinging unit 1 swings (such as changing from a vertical state to a tilted state). The abutting element 41 tends to be in a blocked state (i.e., the abutting element 41 and the second stopping element 51 tend to be in an interfered/blocked state). The rotational force of the stopping device 5 is applied to the pre-abutting element 42 through the first stopping element 50. Due to the rotational thrust, the first stopping element 50 detaches from the pre-abutting element 42, and the blocking portion 402 crosses the first stopping element 50. The stopping unit rotates. The second stopping element 51 moves towards the abutting element 41, and the second stopping element 51 and the abutting element 41 are in an interfered/blocked state. As, the pool cleaner is in a non-moving state, there is no resistance of water pressing against the swinging unit 1. The swinging unit 1 is restored due to a restoring force (which can be buoyancy, elastic force, or gravity, etc.) (for example, the swinging unit 1 is restored to a vertical state). The second stopping element 51 and the abutting element 41 detach. The second stopping element 51 passes through the through-portion 401, i.e. the first stopping element 50/second stopping element 51 and the pre-abutting element 40/abutting element 41 are in a detached state. The stopping unit continues to rotate until it reaches another abutting position. The first stopping element 50 is in a blocked state with the pre-abutting element 42 located at that abutting position. Due to the rotation of the stopping unit, the water discharge direction of the water channel changes and corresponds to another water outlet of the pool cleaner. In this way, the pool cleaner changes its direction of travel and moves away from the pool wall or obstacle, thereby achieving the purpose of direction change and travel.

In a specific implementation of the other working state, a direction change process of the pool cleaner under the mechanical direction change effect is as follows. The pool cleaner is working, and the stopping unit is rotating. When the stopping unit rotates to an abutting position, the first stopping element 50 and the pre-abutting element 42 come into contact and are in blocked positions. The water outlet of the water channel corresponds basically to one of the water outlets of the pool cleaner. The water outlet of the pool cleaner sprays water to drive the pool cleaner to move. During the movement of the pool cleaner (there is a thrust generated by the resistance of the water), due to the rotational thrust of the stopping unit and the resistance of the water, the swinging unit 1 swings, driving the first stopping element 50 to detach from the pre-abutting element 42. The blocking portion 402 crosses the first stopping element 50. The second stopping element 51 is in contact with the abutting element 41, and the abutting element 41 blocks the rotation of the second stopping element 51. The second stopping element 51 and the abutting element 41 are in an interfered (blocked) state (for example, to cause the swinging element 1 to be in (maintain) an inclined state). The rotation of the rotating water channel 7 is restricted, and the stopping unit stops rotating. Under the continuous action of the resistance of the water, the swinging element 1 maintains a tilted state, and the abutting element 41 maintains a blocked state, and the pool cleaner moves in one direction. When the pool cleaner stops moving (due to a wall or an obstacle), the resistance of the water disappears, that is, the thrust of the water flow acting on the swinging element 1 disappears. The swinging unit 1 is restored due to a restoring force (which can be buoyancy, elastic force, gravity, etc.) (restoring a vertical state from a tilted state). The second stopping element 51 detaches from the abutting element 41, and the second stopping element 51 passes through the through-portion 401. The rotating water channel 7 rotates, and the stopping unit rotates to the other abutting position. The water outlet of the water channel rotates to another water outlet of the pool cleaner to spray water, thereby completing the direction change.

The above process is repeated to achieve the travel and direction change of the pool cleaner inside the pool.

In the two working states, when second stopping element II 51 and the abutting element 41 maintain an interfered/blocked state, the swinging unit 1 is in a tilted state.

The technical solution adopts a stopping device (stopping unit) and an abutting assembly (abutting unit) located on the swinging element. The stopping device is located on the rotating element of the pool cleaner and rotates with the rotation of the rotating element. The swinging element is connected to the shell of the pool cleaner and is swingable relative to the shell. Through the rotation of the stopping device, the stopping device comes into contact or detaches from the abutting element during the travel process of the pool cleaner. When the pool cleaner encounters a wall or an obstacle, the swinging element is restored to a vertical state, thereby achieving the direction change. The design features a simple structure, convenient mounting, and smooth operation.

According to the structure of the swinging element, the stopping device is provided with stopping element I (first stopping element) and stopping element II (second stopping element). The stopping element I and the stopping element H are located on the same side of the rotating element. The height of the stopping element I is smaller than that of the stopping element U. In this way, the abutting element crosses the stopping element I and comes into contact with the stopping element II during the travel process of the pool cleaner. The design ensures that the pool cleaner is in a stable state during travel, avoiding the swinging element from detaching from the stopping element in case of an excessive swinging angle.

When the stopping element I and the stopping element II are located at the two sides of the rotating element, there is a height difference between the stopping element I and the stopping element H in the vertical direction. The stopping element I is located above and in contact with abutting element I (the pre-abutting element). When the stopping element I crosses the abutting element I, the stopping element II below contacts abutting element H (the abutting element). In the design, during the travel process of the pool cleaner, the stopping device contacts the abutting element to ensure that the pool cleaner is in a stable state during travel, avoiding the swinging element from detaching from the stopping element in case of an excessive swinging angle.

Embodiments of the present disclosure are described in detail above, but the contents are only preferred embodiments of the present disclosure and cannot be considered as limiting the scope of embodiments of the present disclosure. Any equivalent modifications, improvements, etc. made within the application scope of the present disclosure should fall within the protection scope of the present disclosure.

What is claimed is:

1. A mechanical direction change structure for a pool cleaner, comprising:
a swinging unit, connected to a pool cleaner body and swingable relative to the pool cleaner body;
at least one abutting unit, connected to the swinging unit; and
at least one stopping unit, rotatably connected to the pool cleaner body;
wherein during an operation process of the pool cleaner, the stopping unit is located at a position where the stopping unit interferes with or detaches from the abutting unit.

2. The mechanical direction change structure according to claim 1, wherein when the pool cleaner is moving, the swinging unit is tilted backwards relative to the pool cleaner due to a resistance of water, and the abutting unit keeps interfering with the stopping unit.

3. The mechanical direction change structure according to claim 1, wherein when the pool cleaner is obstructed, due to a rotational force of the stopping unit, the stopping unit rotates to a position where the stopping unit interferes with another abutting unit.

4. The mechanical direction change structure according to claim 1, wherein when the pool cleaner is obstructed and the abutting unit interferes with the stopping unit, the abutting unit is allowed to detach from interfering with the stopping unit due to a rotational force of the stopping unit.

5. The mechanical direction change structure according to claim 1, wherein when the pool cleaner is obstructed and the swinging unit is restored from a tilted state to be vertical to the pool cleaner body, the stopping unit detaches from the abutting unit.

6. The mechanical direction change structure according to claim 1, wherein the stopping unit is connected to the pool cleaner body through a rotating element; the rotating element is a rotating water channel of the pool cleaner, or the rotating element is fixedly connected to a rotating water channel of the pool cleaner;
the rotating water channel is a discharge channel of the pool cleaner and is rotatably connected to the pool cleaner body; and
different positions of the discharge channel correspond to different movement directions of the pool cleaner.

7. The mechanical direction change structure according to claim 1, wherein the stopping unit comprises a first stopping element and a second stopping element, wherein the first stopping element is adjacent to the second stopping element.

8. The mechanical direction change structure according to claim 7, wherein the first stopping element and the second stopping element respectively interact with different abutting positions or different abutting elements of a same abutting unit to achieve an interfered or detached state.

9. The mechanical direction change structure according to claim 7, wherein during a rotation process of the stopping unit, the abutting unit first passes through a position of the first stopping element, and then passes through a position of the second stopping element.

10. The mechanical direction change structure according to claim 7, wherein the first stopping element and the second stopping element are located on different circumferences, and a height of the first stopping element is different from a height of the second stopping element; and
the circumferences are centered on a rotation center of a rotating water channel.

11. The mechanical direction change structure according to claim 10, wherein a highest point of the first stopping element in a vertical direction is lower than a highest point of the second stopping element in the vertical direction.

12. The mechanical direction change structure according to claim 7, wherein when the first stopping element and the abutting unit change from an interfered state to a detached state, the second stopping element and the abutting unit change from a detached state to an interfered state.

13. The mechanical direction change structure according to claim 7, wherein due to a rotational force of the stopping unit, the first stopping element changes from a position of interfering with the abutting unit to a position of detaching from the abutting unit.

14. The mechanical direction change structure according to claim 7, wherein when the pool cleaner is moving, the swinging unit is tilted backwards relative to the pool cleaner due to a resistance of water, and the second stopping element is located at a position where the second stopping element interferes with the abutting unit.

15. The mechanical direction change structure according to claim 7, wherein when the pool cleaner is obstructed and the swinging unit is restored from a tilted state to be vertical to the pool cleaner body, the first stopping element and the second stopping element detach from the abutting unit.

16. The mechanical direction change structure according to claim 7, wherein due to a rotational force of the stopping unit, the first stopping element changes from a position of interfering with the abutting unit to a position of detaching from the abutting unit, and the second stopping element changes from a position of detaching from the abutting unit to a position of interfering with the abutting unit;
(1) when the pool cleaner is obstructed, the swinging unit is restored to a vertical position, the second stopping element detaches from the abutting unit, and the stopping unit rotates until the first stopping element or the second stopping element interferes with another abutting unit; and/or
(2) when the swimming pool cleaning is moving, due to a resistance of water, the swinging unit is tilted backwards relative to the pool cleaner in a vertical plane of the swinging unit, and the second stopping element interferes with the abutting unit.

17. The mechanical direction change structure according to claim 1, comprising two abutting units.

18. The mechanical direction change structure according to claim 17, wherein the two abutting units are connected in a swinging manner to the pool cleaner body, and the two abutting units are fixedly connected to the swinging unit.

19. The mechanical direction change structure according to claim 1, 7 or 17, wherein the abutting unit comprises a pre-abutting element (portion) and an abutting element (portion); the pre-abutting element (portion) is fixedly connected to the abutting element (portion); and a swinging of the swinging unit corresponds to a movement of the pre-abutting element (portion) and the abutting element (portion).

20. The mechanical direction change structure according to claim 19, wherein a lowest point of the pre-abutting element (portion) in a vertical direction is not at a same height as a lowest point of the abutting element (portion) in the vertical direction.

21. The mechanical direction change structure according to claim 19, wherein a lowest point of the abutting element (portion) in a vertical direction is higher than a lowest point of the pre-abutting element (portion) in the vertical direction.

22. The mechanical direction change structure according to claim 19, wherein the abutting element (portion) and/or the pre-abutting element (portion) are connected in a swinging manner to the pool cleaner body; and
the abutting element (portion) and/or the pre-abutting element (portion) are fixedly connected to the swinging unit.

23. The mechanical direction change structure according to claim 19, wherein the pre-abutting element (portion) and the first stopping element interact with each other to be in interfered or detached positions; and the abutting element (portion) and the second stopping element interact with each other to be in interfered or detached positions.

24. The mechanical direction change structure according to claim 1, wherein when the pool cleaner is moving, the swinging unit is tilted backwards relative to the pool cleaner body; and
when the pool cleaner is obstructed, the swinging unit is in a state selected from: (i) the swinging unit is tilted backwards relative to the pool cleaner body; and (ii) the swinging unit is vertical to the pool cleaner body.

25. The mechanical direction change structure according to claim 24, wherein the swinging unit is restored from a tilted state to a vertical state through buoyancy, gravity, or elastic force.

26. The mechanical direction change structure according to claim 1, 7, 17 or 24, wherein the swinging unit comprises at least one resistance plate, and the resistance plate is connected to the abutting unit in one of the following ways:
different resistance plates are connected to different abutting units, or one resistance plate is connected to different abutting units, or one resistance plate is connected to a same abutting unit.

27. The mechanical direction change structure according to claim 26, wherein the resistance plate is fixedly connected to the abutting unit, and the abutting unit is connected in a swinging manner to the pool cleaner body.

28. The mechanical direction change structure according to claim 26, wherein the swinging unit comprises a U-shaped resistance plate, and two ends of the U-shaped resistance plate are respectively connected to different abutting units.

29. The mechanical direction change structure according to claim 1, comprising:
(i) a U-shaped resistance plate;
(ii) two abutting units, wherein each of the two abutting units comprises a pre-abutting element (portion) and an abutting element (portion); and
(iii) a stopping unit, comprising a first stopping element and a second stopping element;
wherein two ends of the U-shaped resistance plate are respectively fixedly connected to the two abutting units;
the two abutting units are connected in a swinging manner to the pool cleaner body;
the first stopping element and the second stopping element are rotatable relative to the pool cleaner; and
during a rotation process of the stopping unit, the first stopping element and the pre-abutting element (portion) are in an interfered state or a detached state, and the second stopping element and the abutting element (portion) are in an interfered state or a detached state.

30. The mechanical direction change structure according to claim 29, wherein each of the two ends of the U-shaped resistance plate is fixedly connected to the abutting element (portion); the abutting element (portion) is fixedly connected to the pre-abutting element (portion); and the pre-abutting element (portion) is connected in a swinging manner to the pool cleaner body through a shaft.

31. The mechanical direction change structure according to claim 29, wherein the first stopping element and the second stopping element are fixedly connected to a rotating water channel of the pool cleaner and are adjacent to each other; and
the first stopping element and the second stopping element are located on different circumferences; a highest point of the first stopping element in a vertical direction is lower than a highest point of the second stopping element in the vertical direction; and
when the U-shaped resistance plate is in a vertical state, a lowest point of the abutting element (portion) in the vertical direction is higher than a lowest point of the pre-abutting element (portion) in the vertical direction.

32. A pool cleaner, comprising the mechanical direction change structure according to claim 1.

33. The pool cleaner according to claim 32, further comprising a top shell and a bottom shell; wherein the top shell and the bottom shell are detachably connected; a rotating water channel is provided in the top shell; and water flows through a water inlet of the bottom shell and is discharged through a water outlet of the rotating water channel; and
when the pool cleaner is running, the rotating water channel rotates under an action of a power unit.

34. The pool cleaner according to claim 33, wherein the swinging unit and the abutting unit of the mechanical direction change structure are fixedly connected, and the abutting unit is connected in a swinging manner to the top shell.

35. The pool cleaner according to claim 33, wherein the top shell is provided with an opening corresponding to the water outlet of the rotating water channel.
